(19) United States
(12) Patent Application Publication
(10) Pub. No.: US 2006/0265289 A1
(43) Pub. Date: Nov. 23, 2006

(54) Community-based method and system for the sale of goods and services

(76) Inventor: Joseph Bradford Bellissimo, Calabasas, CA (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/133,826

(22) Filed: May 19, 2005

(51) Int. Cl. G06Q 30/00

(52) U.S. Cl. 705/26

(57) ABSTRACT

A method and system for selling a fixed quantity of products (goods and/or services) during a fixed period of time is described. A first offer to sell the product is made to a community of buyers. Each sold unit of the product may be offered for resale until the fixed period of time expires. If the products are goods, once the fixed period of time expires, they are shipped to their current owners.

### FIELD OF THE INVENTION

The present invention relates generally to the sale of goods and services, and more particularly, to a community-based method and system for selling goods and services.

### BACKGROUND OF THE INVENTION

For vendors of goods and services, it is desirable to create consumer interest or “buzz” about a new product offering prior to the product's launch. By developing such consumer interest, product vendors can improve their chances of placing their products in well-known, high visibility consumer retail outlets. In addition, they can improve the likelihood of strong initial sales. Also, by creating consumer interest prior to a product launch, vendors may be able to increase the price at which their goods or services are sold.

Prior techniques for stimulating consumer interest include costly advertising techniques such as television and print advertising. While such techniques showcase a product's attributes and possibly stimulate consumer interest, their ability to stimulate consumer interest is somewhat limited. The limitations of such techniques stem from the fact that their success depends largely on the extent to which the advertisements and the products appeal to—and reach—the product's target consumers.

Given the foregoing, it is desirable to create an environment where consumers are offered the opportunity to buy products at a substantially reduced rate and to make speculative purchases and sales of products, especially of goods or services that are not yet available in traditional retail outlets. By providing such an environment, consumer interest can be stimulated by the “buzz” created when a new product is sold and re-sold at escalating prices. Thus, instead of simply assessing a product's value based on its inherent properties and obvious attributes (e.g., color, shape, price), consumers can assess a product's value based on the sales traffic that is created when consumers are afforded the opportunity to buy the product at a discount and resell it at a profit. By creating the possibility of such speculative profits, those who ordinarily would be uninterested in a product may nevertheless purchase it in the hopes that others may be sufficiently interested in it to buy it from them. If a product is sold and re-sold at increasing prices, word of its popularity is likely to spread, causing increased consumer demand and the potential for selling the product at higher prices. Accordingly, a need has arisen for an invention that addresses the foregoing issues.

### SUMMARY OF THE PREFERRED EMBODIMENTS

In accordance with a first aspect of the present invention, a method of selling a fixed quantity of a product during a fixed period of time is provided. The method comprises transmitting a first offer to sell the product to a community of buyers and transmitting a first resale offer to sell a unit of the product to the community of buyers. The first offer to sell and the first resale offer to sell preferably expire no later than the fixed period of time expires.

In preferred embodiments, the product is one selected from the group consisting of goods and services. In other preferred embodiments, one unit of the product is sold to a first buyer, thereby defining a first sale and a sold product, and the resale offer to sell comprises a resale offer to sell the sold product. In other preferred embodiments, the step of transmitting a first offer to sell occurs at an offer transmission time, the first sale occurs at a first sale time, the first sale time and the offer transmission time define a first sale period between the offer transmission time and the first sale time, and the first resale period is no more than the difference between the fixed period of time and the first sale period.

In yet additional preferred embodiments, the product is a good, and the method further comprises the step of transmitting an inquiry regarding the disposition of the sold good to the first buyer after the first sale of the good, wherein the disposition is one selected from the group consisting of shipping the sold good to the first buyer and reselling the sold good to the community of buyers. In still other preferred embodiments, the step of transmitting a first offer to sell the product to a community of buyers comprises transmitting an electronic mail message to at least a portion of the community of buyers. In further preferred embodiments, the step of transmitting a first offer to sell the product to a community of buyers comprises transmitting a cellular telephone text message to at least a portion of the community of buyers.

In still further preferred embodiments, the sold unit of the product is resold to a second buyer, thereby defining a second sale of the sold unit of the product, and the method further comprises transmitting a second resale offer to sell the sold unit of the product to the community of buyers, the second resale offer comprising a second resale price and expiring no later than a second resale period expires. In additional preferred embodiments, the product is a good and following the fixed period of time, the fixed quantity of goods comprises a quantity of sold goods, each sold good has a corresponding owner, and each sold good is shipped to its corresponding owner. In yet other preferred embodiments, the method comprises providing a vendor transaction report comprising a number of sales transactions conducted during the fixed period and a sales price corresponding to each transaction.

In accordance with another aspect of the present invention, a method of selling a fixed quantity of a product during a fixed period is provided. The method preferably comprises transmitting an offer to sell the product to a community of buyers, and receiving a request from a member of the community to purchase a unit of the product. In preferred embodiments, the method further comprises determining a quantity of the product currently held, determining a quantity of the product sold, and determining whether any units of the product are currently available for purchase based on the fixed quantity of the product, the quantity of the product currently held and the quantity of the product sold. In other preferred embodiments, the method comprises transmitting a response to the request to purchase a unit of the product, wherein the response is based on whether any units of the product are currently available for purchase.

In additional preferred embodiments, the method further comprises receiving at least one request to hold one unit of the product for a hold period, and the step of determining the quantity of the product currently held comprises determining whether the hold period has expired. In still other preferred embodiments at least one unit of the fixed quantity of the product is sold to a buyer, thereby defining a quantity of the sold product, each sold product has a corresponding buyer, and the response comprises a message directing the member to a turnaround feature.

In accordance with yet another aspect of the present invention, a system for selling a fixed quantity of a product is provided. The system preferably comprises a computer server programmed to transmit a first offer to sell the product to a community of buyers and transmit resale offers to sell the product to the community of buyers, wherein the first offer and resale offer expire not later than a fixed period of time following a transmission of the first offer to sell to the community of buyers. In a preferred embodiment, the computer server is operatively connected to a communications network. In still other preferred embodiments, the communications network comprises at least one selected from the group consisting of a local area network, a wide area network, the internet, and a cellular telephone network. In yet other preferred embodiments, the server has a product information database stored thereon, the product information database includes a plurality of data fields related to at least one product, and the first offer includes information contained in at least one of the data fields for at least one of the products.

In accordance with still another aspect of the present invention, a computer readable medium is provided. The computer readable medium preferably has instructions stored thereon for causing a computer to transmit a first offer to sell a fixed quantity of a product to a community of buyers and transmit a first resale offer to sell a sold unit of the product to the community of buyers. In preferred embodiments, the first offer to sell and the first resale offer to sell expire no later than a fixed period of time following a transmission of the first offer to sell to the community of buyers.

In accordance with a further aspect of the present invention, a method of marketing a product having a retail price is provided. The method preferably comprises offering a fixed quantity of the product for sale to a community of buyers at a discount price for no more than a fixed period of time. The method also preferably comprises selling at least one unit of the product in the fixed quantity of the product to a buyer in the community of buyers, thereby defining a sold product. The method further preferably comprises reselling the sold unit of the product at least once during the fixed period of time. In a preferred embodiment, the method further comprises providing a vendor transaction report that comprises a number of sales transactions conducted during the fixed period and a sales price corresponding to each transaction.

In accordance with another aspect of the present invention, a system for selling a fixed quantity of a product during a fixed period of time is provided. The system preferably comprises a computer server programmed to transmit an offer to sell the product to a community of buyers. The server is also preferably programmed to receive a request from a member of the community of buyers to purchase a unit of the product and determine a quantity of the product currently held. The server is further preferably programmed to determine a quantity of the product sold and determine whether any units of the product are currently available for purchase based on the fixed quantity of the product, the quantity of the product currently held and the quantity of the product sold. In a preferred embodiment, the server is programmed to transmit to the member a response to the request to purchase a unit of the product, wherein the response is based on whether any units of the product are available for purchase.

In accordance with yet another aspect of the present invention, a system for selling a fixed quantity of a product is provided. The system preferably comprises a computer server programmed to include a purchase feature configured to receive requests to purchase the product during a fixed period of time and a hold feature configured to receive requests to purchase an option to buy the product during an option period. The option period preferably expires no later than the fixed period of time expires.

In accordance with still another aspect of the present invention, a system for selling a product is provided. The system preferably comprises a purchase feature configured to receive requests to purchase the product during a fixed period of time and a turnaround feature. The turnaround feature is preferably configured to transmit offers to resell sold units of the product for a period of time that expires no later than the fixed period of time expires.

### BRIEF DESCRIPTION OF THE DRAWINGS

The invention may be more readily understood by referring to the accompanying drawings in which:

FIG. 1 is a depiction of a communications system for implementing a preferred embodiment of a method of selling products in accordance with the present invention;

FIG. 2 is a depiction of a computer suitable for implementing certain of the features of the present invention;

FIG. 3 is a flow chart depicting a method of selling products in accordance with a preferred embodiment of the present invention;

FIG. 3A is a depiction of a membership information input screen in accordance with a preferred embodiment of the present invention;

FIG. 4 is a flow chart depicting a method of selling products in accordance with a preferred embodiment of the present invention;

FIG. 5 is a flow chart depicting a preferred embodiment of a method of reselling products in accordance with a preferred embodiment of the present invention;

FIG. 6 is a depiction of a vendor information input screen in accordance with a preferred embodiment of the present invention;

FIG. 7 is a product information input screen in accordance with a preferred embodiment of the present invention;

FIG. 7A is depiction of an initial community offer e-mail in accordance with a preferred embodiment of the present invention;

FIG. 8 is a depiction of a home web page in accordance with a preferred embodiment of the present invention;

FIG. 9 is a depiction of a turnaround feature implemented in a web page in accordance with a preferred embodiment of the present invention;

FIG. 10 is a user home web page in accordance with a preferred embodiment of the present invention;

FIG. 11 is a vendor report in accordance with a preferred embodiment of the present invention;

FIG. 12 is a hold request pop-up window in accordance with a preferred embodiment of the present invention;

FIG. 13 is a sold item disposition pop-up window in accordance with a preferred embodiment of the present invention; and

FIG. 14 is a purchase request pop-up window in accordance with a preferred embodiment of the present invention.

Like numerals refer to like items throughout the several views of the drawings.

### DETAILED DESCRIPTION OF THE PREFERRED EMBODIMENTS

The present invention is directed to a method and system for conducting sales of products, i.e. goods or services. The method can be implemented in a number of ways, and the embodiments described herein, while presently preferred, are not meant to limit the scope of the invention which is to be defined solely by the appended claims.

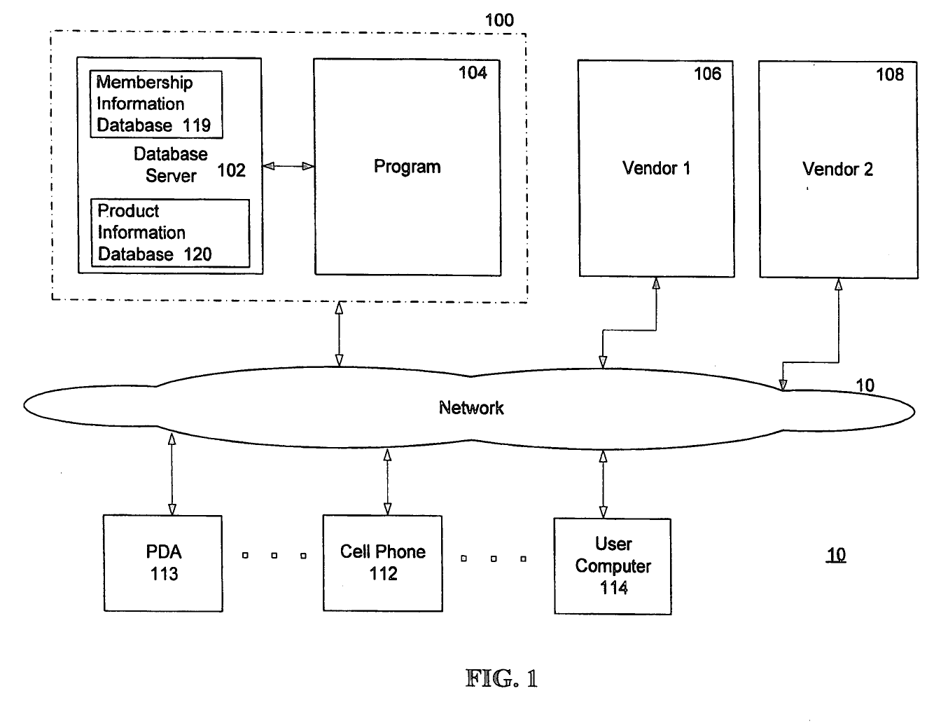

Referring to FIG. 1, a communications system 10 configured to implement a method of conducting sales transactions in accordance with the present invention is described. Communications system 10 preferably comprises a server system 100 having a database server 102 and a program 104 that stores executable instructions necessary to access and present the information from, and store information to, product information database 120 and membership information database 119. Communications system 10 also preferably includes one or more user devices, such as cell phone 112, personal data assistant (“PDA”) 113 and/or user computer 114. PDA 113 and user computer 114 access server system 300 via network 110. Other systems, such as vendor systems 106 and 108 may also be operatively connected to network 110, to allow access to server system 100. In the embodiment of FIG. 1, network 110 represents a variety of networks which may include one or more local area networks, wide area networks, the internet, and cellular telephone networks.

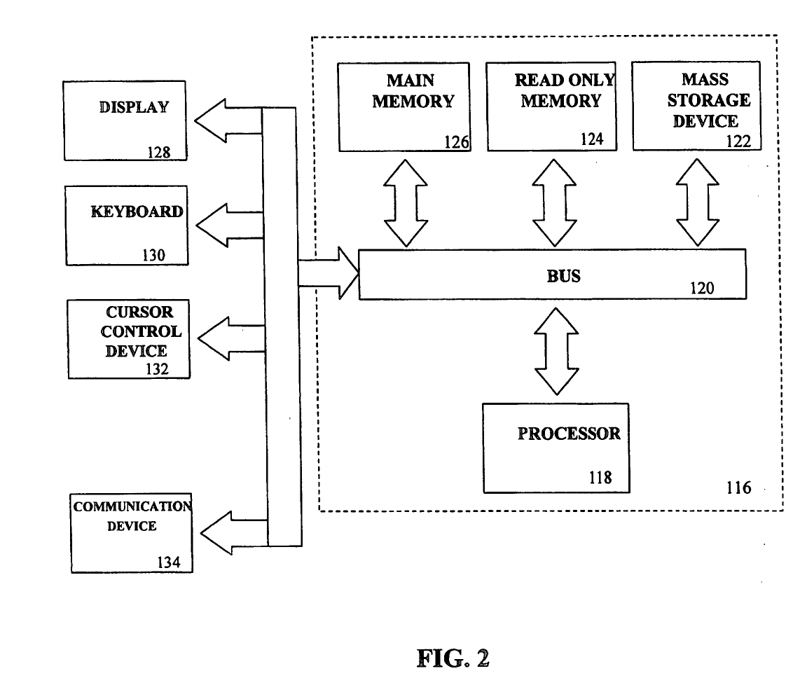

FIG. 2 illustrates an example of a computer system 116 in which the features of the present invention may be implemented. For example, the functionality provided by database server 102, program 104, vendor systems 106 and 108 and user computer 114 may be implemented using a computer system such as computer system 116. However, the present invention is not limited to computerized implementations or the use of the specific computer system depicted in FIG. 2. For example, the functionality provided by database server 102 and program 104 may be combined in one computer system or redistributed over several computers. Moreover in a preferred embodiment, system server 120 comprises a plurality of servers coupled to a load balancing device which enables communications to and from system users to be apportioned amongst the servers.

Referring to FIG. 2, computer system 116 includes a bus 120 for communicating information between the components in the computer system 116, and a processor 118 coupled with the bus 120 for executing software code, or instructions, and processing information. Computer system 116 further comprises a main memory 126, which may be implemented using random access memory (RAM) and/or other random memory storage device, coupled to the bus 120 for storing information and instructions to be executed by processor 118. Computer system 116 also includes a read only memory (ROM) 124 and/or another static storage device coupled to bus 120 for storing static information and instructions for processor 118.

Further, a computer readable medium, such as a mass storage device 122, a magnetic-disc drive and/or an optical disc drive, may be coupled to the computer system 116 for storing information and instructions. In addition, other devices capable of reading computer readable media may be provided, such as floppy disc drives, zip disc drives, jaz disc drives, and compact disc (CD) drives. Computer system 116 can also be coupled via bus 120 to a display device 128 such as a cathode ray tube (CRT) or a liquid crystal display (LCD), for displaying information to a user so that, for example, graphical or textual information may be presented to the user on display device 128. Typically, an alpha-numeric input device 130, including alpha-numeric and other key is coupled to bus 120 for communicating information and/or commands to processor 118. A cursor control device 132, such as a conventional mouse, touch mouse, trackball, track pad or other type of cursor keys may also be used to communicate direction information and command selection to processor 118 and control movement of a cursor on display 128.

A communication device 134 is also coupled to bus 120 and provides access to other computer systems coupled to network 110. Communication device 134 may include a modem, network interface card, or other well-known interface devices, such as those used to interface to Ethernet, Token-ring or other types of networks.

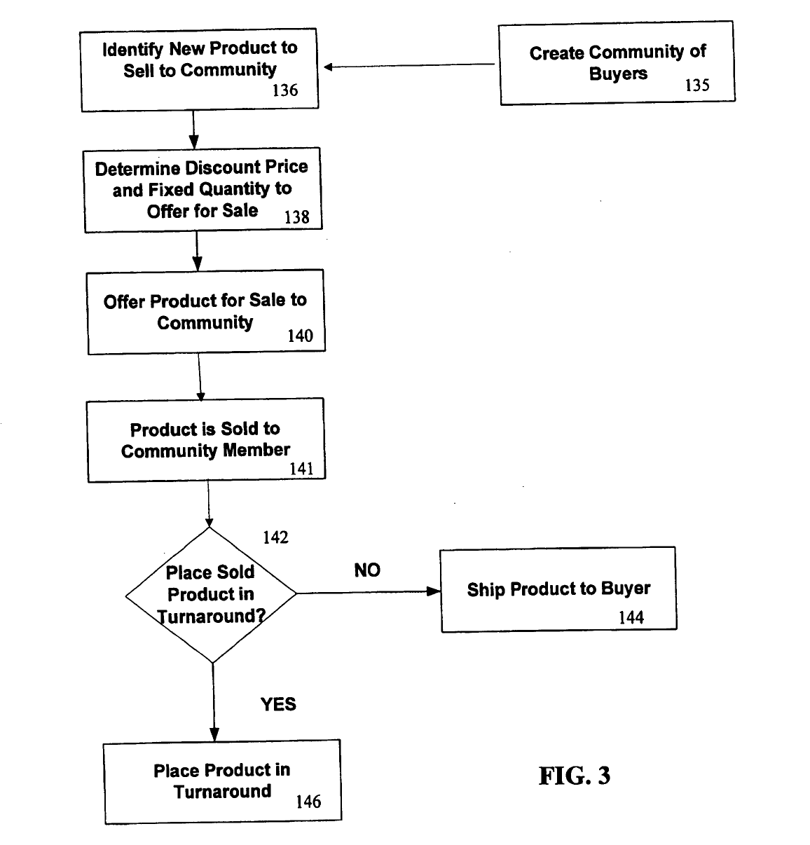

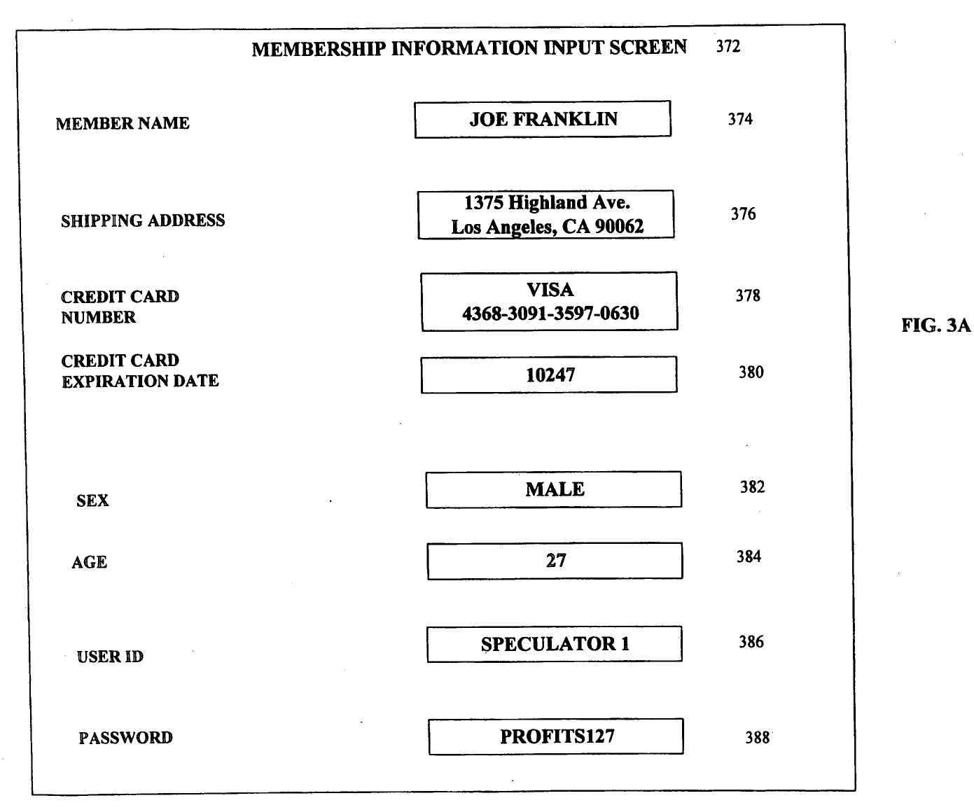

Referring now to FIG. 3, a preferred embodiment of a method of selling products is described. As used herein, the term “products” refers to goods and/or services. Although certain of the specific embodiments discussed herein refer to sales of goods, the present invention may also be used to sell services.

In accordance with this embodiment, a community operator first creates a community of buyers (step 135). The community operator is an individual or entity responsible for running certain affairs of the community of buyers. The community of buyers preferably comprises a plurality of individuals, each of whom pays a periodic subscription fee (for example a monthly or annual fee), for the opportunity to purchase products at discounted prices for limited periods of time. Members can preferably join the community in a number of ways, including by using a conventional telephone or cellular telephone to call a pre-defined member subscription telephone number, or thorough a graphical user interface on user computer 114, such as a web page. In a preferred embodiment, members pay the fee with a credit card and input their credit card number into a data entry field on a member information input screen, as will be described further below. The member's credit card number will also preferably be used to purchase items offered for sale to the community as described below.

After a community of buyers has been created, a new product is identified for eventual sale to the community (step 136). The new product will preferably be an item that has not yet been made available to consumers or which has only been made available for a short period of time. Exemplary products include articles of men's or women's clothing and accessories, electronic devices such as computers, stereos or digital music recording devices, sporting equipment, children's toys, collectible items and memorabilia, and travel services.

The selected product will preferably have a suggested or established retail price used in conventional retail outlets, such as stores or mail order houses. The product's commercial vendor or distributor will also preferably be willing to sell the product at a discounted rate for a limited period of time to the community of buyers as a means of generating consumer interest for the product.

In accordance with the method, a discounted price is determined (step 138) at which the product will be offered to the community of buyers. The offer will preferably be limited to a fixed quantity of goods, which is also selected. If services are to be offered, then a fixed number of service events (e.g. 10 massages) is selected. The fixed quantity of goods or services is preferably based on a specified percentage of the total community membership. The fixed quantity will generally be from about 30% to about 70% of the community membership, preferably from about 40% to about 60% of the community membership, and more preferably from about 45% to about 55% of the community membership.

In a preferred embodiment, the products offered for sale are goods and the fixed quantity of goods will be stored in one or more warehouses pending the completion of the sale to the community. The commercial vendor or distributor of the goods may retain title to them, or title may be transferred to the community operator. However, in a preferred embodiment, the community operator will purchase the goods at a first discounted price from the commercial vendor or distributor and offer them for sale to the community at a second discounted price, such that the second discounted price is greater than the first discounted price. The difference between the first and second discounted prices preferably comprises a commission collected by the community operator in return for its promotion of the vendor's product.

The selected fixed quantity of the product is then offered for sale to the community at the selected discounted price (step 140). The offer is preferably held open until a fixed period of time expires or until the fixed quantity is exhausted, whichever comes first. At the time the offer is made, or subsequent thereto, the community may optionally be informed about the total number of units comprising the fixed quantity and about the fixed period of time.

In accordance with this embodiment, one or more units of the fixed quantity of goods are sold to members of the community at the selected discounted price (step 141). For each unit that is sold, the buyer will preferably have the option of taking shipment of the item (step 144) or reselling the unit to other members of the community and/or non-members of the community, a process which will be referred to as “turnaround” herein (step 146). The fixed quantity of goods may be stored by the vendor, the community operator, or a third party (such as a storage company) until they are shipped to the buyer. Once the fixed period of time expires, any purchased goods are preferably shipped to the party who bought them. Regardless of how they are stored, it is particularly preferred that the purchased items are shipped on the same day as they are purchased to minimize storage costs. Of course, in the case of services, storage costs are not an issue. Thus, the community operator may impose a deadline for accepting performance of the purchased service, or the service vendor and buyer may agree on a mutually convenient time for performance to occur.

As explained below, prior to the expiration of the fixed period of time, each buyer of one of the products will have an opportunity to resell the good to the community. Thus, a particular unit may be sold and resold a number of times. In an especially preferred embodiment, the products, the fixed quantity, and the discount price will be selected to better ensure that the fixed quantity of goods will sell out before the expiration of the fixed period of time. More preferably, one or more of the sold products will be resold multiple times in turnaround. The ability to place items in turnaround and resell them at prices higher than the discount price at which they were initially offered will preferably facilitate speculative buying and attract members to the community, as well as generate interest in the sold goods which will spread to the buying public at large. As a result, this preferred embodiment may be used to market products to the buying public by creating an initial period of repeated sales transactions and speculative buying which stimulate consumer interest in the products.

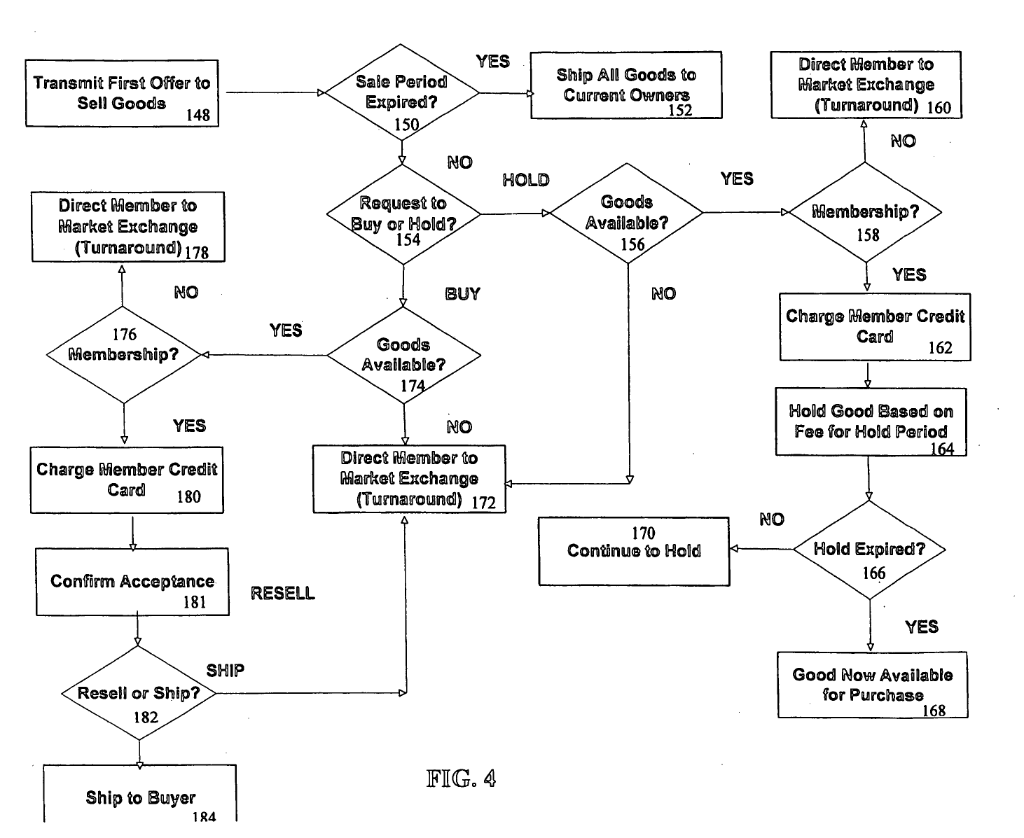

Another embodiment of a method for selling products in accordance with the present invention is described in FIG. 4. Again, although FIG. 4 makes specific reference to the sale of goods, the method described in FIG. 4 can also be used to sell services. In an especially preferred embodiment, the community operator performs one or more of the steps depicted in FIG. 4 by running program 104 which is configured to perform those steps. However, the method of this preferred embodiment may be implemented without the use of a computer program. FIG. 4 shows various sequences of steps that may be used to implement an embodiment of the present invention. However, it is not intended to comprise a complete computer program flow chart and should not be interpreted as such. Certain of the steps could be re-sequenced without departing from the scope of the invention, and FIG. 4 is merely mean to be illustrative of certain of the steps that could be used to implement the present invention.

In accordance with this embodiment, information concerning community members is input into a membership information database 119 via membership information input screen 372, as depicted in FIG. 3A. Membership information input screen 372 preferably includes several data fields, including user name 374, shipping address 376, credit card number 378, credit card expiration date 380, and possibly other demographic information such as sex 382, age 384, and/or other information which can be used to segregate the community into subgroups. By segregating the community into subgroups, offers can be targeted to those subgroups for whom the offers will likely be most appealing. As also indicated in FIG. 3A, the prospective community member also provides a user ID 386 and password 388 which will be used for credentialing purposes to verify the person's membership in the community.

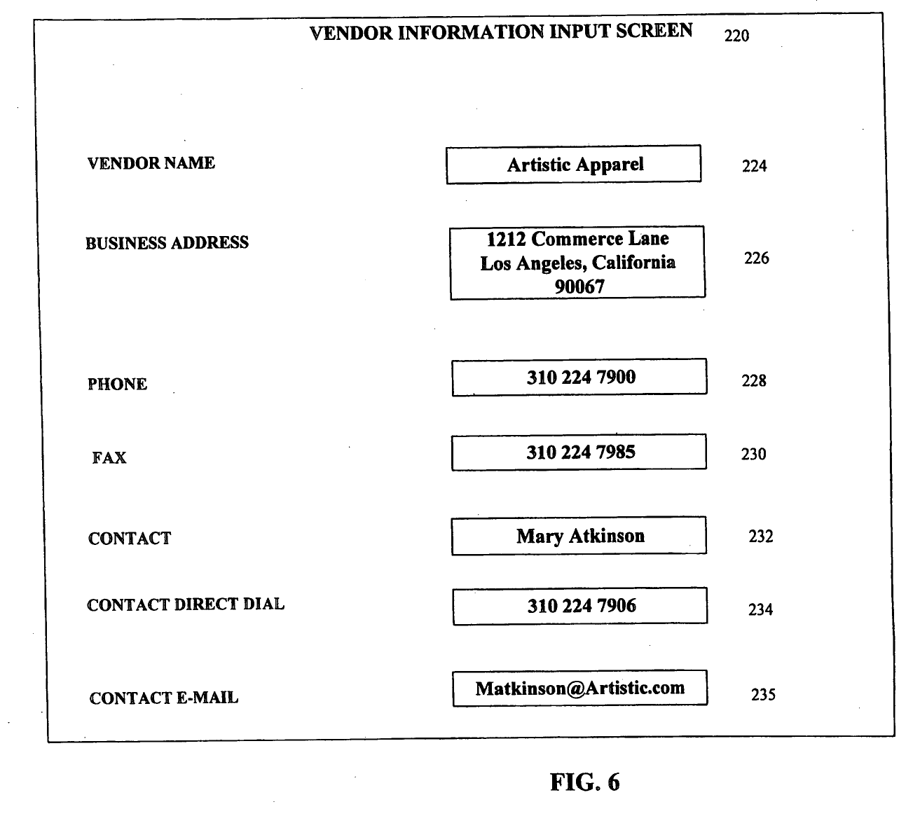

Information concerning a product to be offered for sale is preferably stored in a product information database file 120 which is resident on database server 102. Program 104 is preferably configured to read information from and store information to product information database 120. Referring to FIG. 6, information is preferably stored to the product information database by the community operator or a commercial vendor via a graphical user interface such as Vendor Information Input Screen 220. Vendor Information Screen 220 is preferably generated by program 104 in response to a user command. In the embodiment of FIG. 6, several pieces of information regarding the commercial vendor or distributor can be stored to product information database 120, including vendor name 224, vendor business address 226, vendor phone and fax numbers, 228 and 230, respectively, contact name 232, contact direct dial phone number 234 and contact e-mail address 235. Alternatively, the information in FIG. 6 can be stored to a separate vendor database which is then linked to the product information database using known techniques.

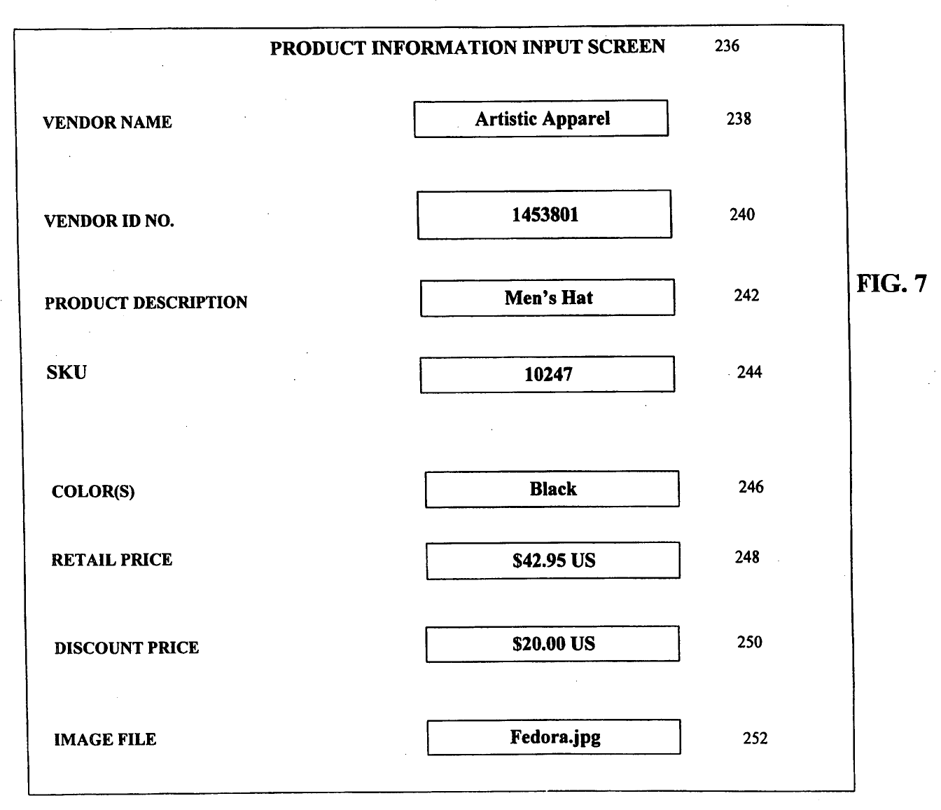

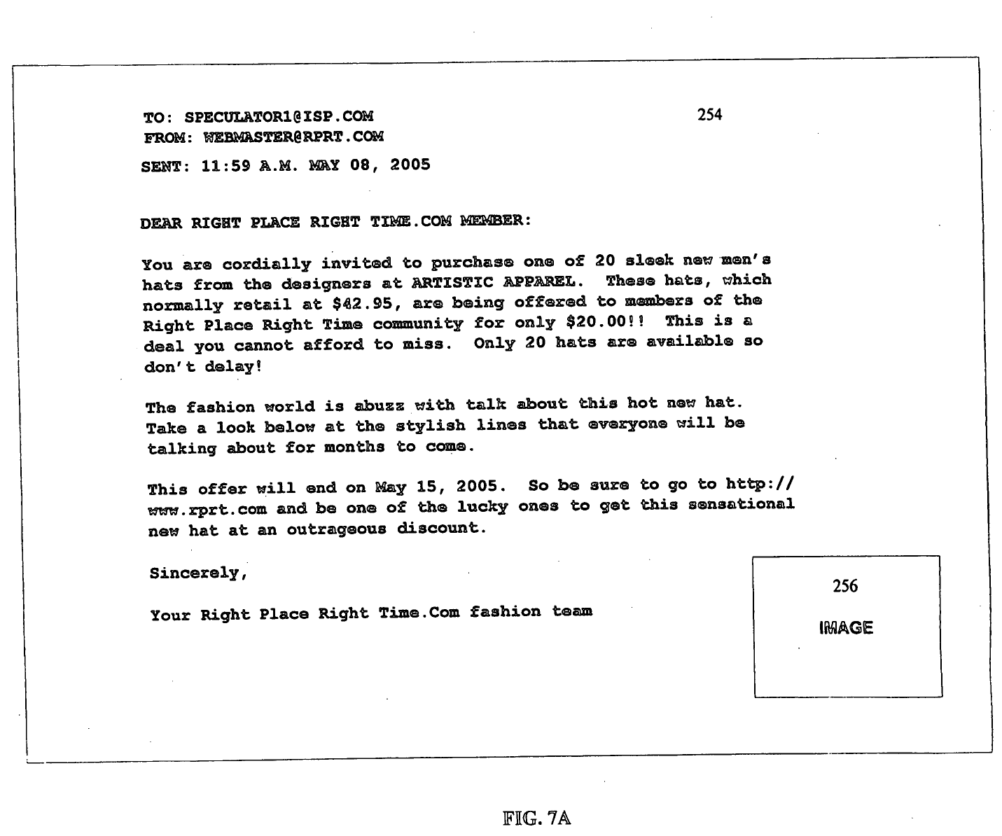

FIG. 7 depicts a preferred embodiment of a product information input screen 236 used by the community operator or commercial vendor/distributor to input product information. In accordance with this embodiment, several data entry fields are provided for entering a vendor name 238, a vendor identification number 240 which is unique to the community, a product description 242, a stock keeping unit (“SKU”) 244, product color 246, suggested or actual retail price 248, discount price 250, and an image file 252. Image file 252 is used to store an image of the product for eventual display to community members.

Server system 100 is preferably configured to include a community offer feature. Referring again to FIG. 4, at step 148, server system 100 transmits an offer to sell a fixed quantity of goods. This initial offer to the community is referred to as an “initial community offer” herein. The initial community offer is preferably in the form of an e-mail accessible by user computer 114, PDA 113 or other wireless devices capable of receiving e-mail messages. In addition, the initial community offer may be in the form of a text message transmitted to a community member's cellular phone 112. Program 104 preferably includes instructions which use a known daemon process to schedule the transmission of the offer e-mail at a pre-selected time. Server system 100 includes or is operatively connected to one or more interface devices that allow e-mails or text messages generated by program 104 to be accessed with user computers 114 which are operatively connected to the world wide web and via wireless application protocol (WAP) enabled devices, including cellular telephones 112 and PDAs 113.

A preferred embodiment of an offer e-mail 254 generated in accordance with the present invention is depicted in FIG. 7A. It is preferred that the e-mails are automatically transmitted to community members by program 104 using known daemon processes and that they include information contained in product information database 120.

The community operator preferably selects a maximum period of time during which the initial community offer will be held open. This period of time is referred to as the “initial community offer period” herein. Thus, the initial community offer will be held open until the fixed quantity of goods is sold out or the initial community offer period expires, whichever occurs first.

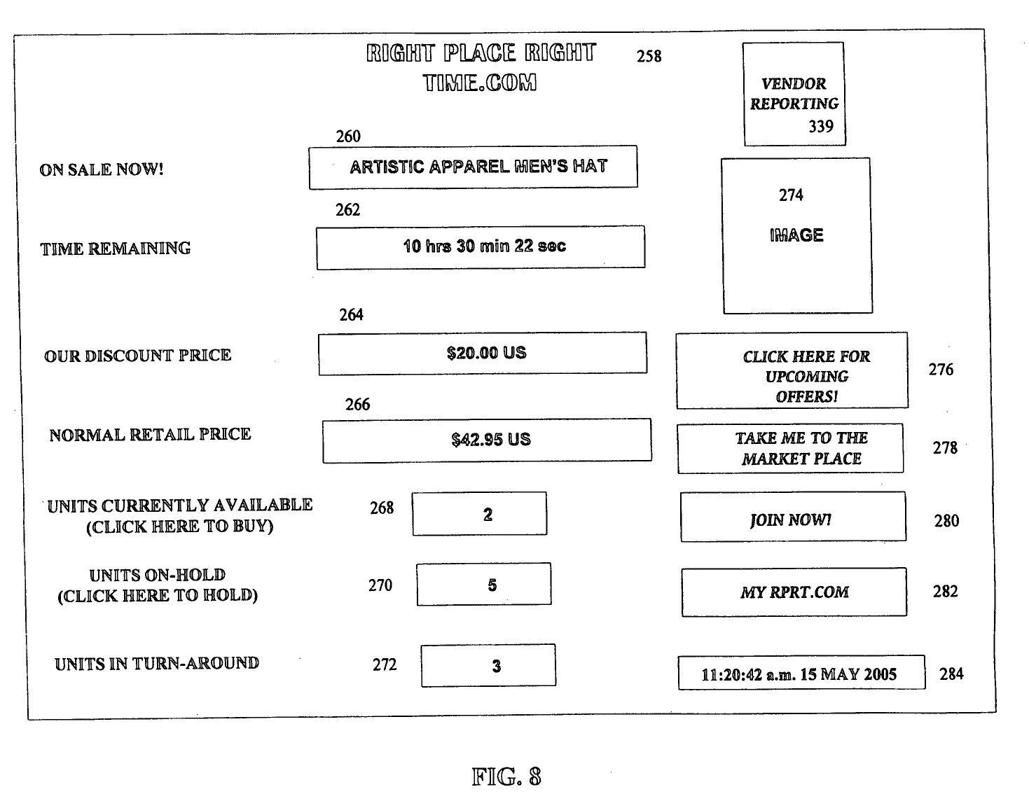

As depicted in FIG. 7A, the initial community offer preferably describes a suggested or actual retail price, a discount price, the fixed quantity, and the initial community offer period or the initial community offer deadline (i.e., the offer transmission date and time plus the initial community offer period). Optionally, the fixed quantity may be excluded from e-mail 254 to create a sense of urgency to in potential buyers as a result of not knowing how many units are available. This sense of urgency will preferably stimulate purchases of offered items or purchases of hold time for the items. In an especially preferred embodiment, known techniques are used to create an image of the product offered for sale in e-mail 254. For example, the e-mail may comprise embedded hypertext markup language (“html”) which is linked to a product image file in a known format such as the .jpeg format. Once the offer is transmitted, recipients wishing to purchase one of the offered items can preferably do so by accessing a purchase feature, which preferably comprises a web site home page 258 as depicted in FIG. 8 and described below.

Referring once again to FIG. 4, following the transmission of offer e-mail 254 in step 148, program 104 will periodically determine the time that has elapsed since the transmission of offer e-mail 254 (step 150). Once the initial community offer period expires, all goods are shipped to their current owners in step 152. Any goods that were not sold to the community of buyers may optionally be shipped back to the vendor. If the community operator paid the vendor for the goods, the community operator will preferably receive a financial credit for any goods returned. In the case of services, once the initial community offer period expires, all current owners may be obligated to accept performance of the purchased services by a date certain or to arrange with the vendor to accept performance on a mutually agreed upon date.

In accordance with this embodiment, community members are preferably provided the option of buying products or holding them for a pre-determined period of time. Thus, server system 100 is preferably configured to include a purchase feature and a hold feature, as explained further below. As used herein, “holding” a product refers to a process by which a user purchases an option to buy a product during a fixed period of time (“hold period”), which preferably expires no later than the initial community offer period. For example, a user may wish to put an item on hold for one day and may pay a flat rate or a time-based rate for putting the item on hold. While on hold, the item will preferably be unavailable for purchase by other members of the community. The member purchasing the hold will preferably have the exclusive right to purchase the product until the hold period expires or until the fixed period terminates, whichever occurs first.

As indicated in step 156, if a user requests to hold an item, program 104 will preferably determine whether any goods are currently available to hold. This determination will preferably be made by computing the difference between the fixed quantity of goods offered to the community in the initial community offer and the sum of the goods already sold and the goods currently on hold:
Q_{available}=Q_{fixed}−(Q_{sold}+Q_{held})

If no units are currently available (Q_{available}=0), then in step 172 the community operator preferably transmits a response to the user's hold request, which more preferably directs the user to the market exchange or turnaround feature of the system. The turnaround feature is preferably a web page used to display offers to resell goods purchased by members of the community, as will be described in greater detail below. In a preferred embodiment, the user is directed to the turnaround feature by providing a message to the user's communication device (e.g., PDA 113 or user terminal 114) indicating that there are no goods currently available to hold but that goods may be available for purchase in the market exchange. Also, program 104 may optionally be configured to create one or more waiting lists of those who were unable to purchase or put items on hold so that when earlier holds expire, the wait-listed individuals will be so notified and given the opportunity to purchase or put an item on hold.

In a preferred embodiment, the ability to use the hold feature to place products on hold is restricted to those persons who were members of the community at the time the initial community offer was transmitted. Accordingly, if units of the goods are currently available, the community operator preferably determines whether the person requesting the hold is a member of the community. In a preferred embodiment, this determination is made using a pop-up window which program 104 displays on user computer 114 or PDA 113. Such pop-up windows are known in the art and provide data entry fields in which members enter a user identification name and a password. Program 104 is preferably configured to receive data from the pop-up window and compare it to data stored in membership information database 119 to verify the person's membership status.

If the community operator is unable to verify that the requesting person is a community member, in step 160 the person is preferably directed to access the turnaround feature to purchase the item. In step 160, the person may also be directed to join the community and provided with a pop-up window which links to the member information input screen 372 (FIG.3A) used to subscribe new members.

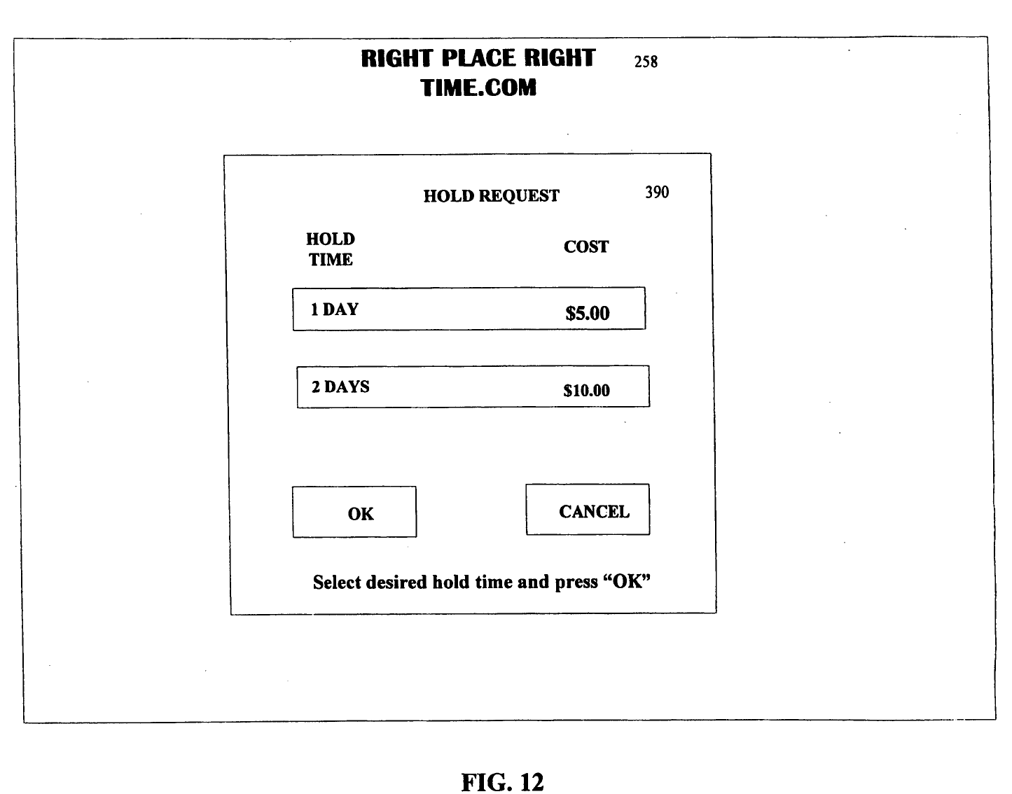

If the community operator determines that the person requesting a hold was a member of the community at the time the initial community offer was transmitted, in step 162 the person's credit card is preferably charged for an amount sufficient to cover a hold fee for the requested hold time. In a preferred embodiment of the hold feature, a pop-up window 390 as shown in FIG. 12 appears on PDA 113 or computer 114 to ask the person how much hold time they would like to purchase. Pop-up window 390 is preferably configured to allow the member to indicate the desired hold time by clicking on a pre-defined region of the pop-up window as shown in FIG. 12. The person's response then determines the fee used in charging the person's credit card in step 162. Alternatively, the hold feature may comprise a separate web page or a telephone number which the member uses to purchase the desired amount of hold time.

Hold time is preferably purchased with a credit card account corresponding to credit card information contained in the membership information database for the hold-purchasing member. Credit card verification and processing are preferably performed using known techniques for performing automated credit card transactions. Processes for automatically performing credit card transactions over communication networks such as the internet are known to those of ordinary skill in the art and will not be described herein. Preferably, network 110 is operatively connected to a credit card processor server system to facilitate such transactions. In a preferred embodiment, each community member's credit card information is stored in the membership information database 119 so it can be automatically retrieved and transmitted to the credit card processor.

In step 164, the community operator places the held item on hold for the purchased period of time. As indicated in step 166, the community operator periodically determines the time that has elapsed since the hold was purchased. If the hold has not expired, then in step 170 it is continued. If the hold has expired, then in step 168, the community operator makes the good available for purchase, thereby increasing the quantity of goods currently available (Q_{available}) as outlined above.

As mentioned above, program 104 preferably checks to determine whether a request to hold or buy an item has been received. As will be explained below, this preferred embodiment includes a purchase feature which is used to communicate purchase requests to the community operator, and more preferably to program 104. In step 154, if a request to buy an item has been received, the community operator preferably proceeds to step 174 and determines if there are any goods available for sale. As described above, the quantity of goods available is preferably calculated as follows:
Q_{available}=Q_{fixed}−(Q_{sold}+Q_{held})

If goods are not currently available (Q_{available}=0), in step 172 program 104 preferably transmits a response to the person requesting the hold which more preferably directs the person to the turnaround feature. If goods are offered for resale, the person can then buy them via the turnaround feature. To direct the person requesting the hold to the turnaround feature, program 104 preferably generates a pop-up message appearing on PDA 113 or user terminal 114 directing the person to the market exchange to purchase an item already owned by a community member. In addition, program 104 may optionally be configured to create a waiting list of those who attempted to but were unable to purchase one of the goods. In a preferred embodiment, if a previously held item comes off of hold status, wait listed members would be given priority to purchase the item.

If goods are currently available (Q_{available}·0), the community operator preferably determines whether the person submitting a request to buy an item is a community member. As described previously, in a preferred embodiment this membership determination is made by transmitting a pop-up window to a user screen on PDA 113 or user terminal 114 and requesting a user identification name and password. Once the user enters these pieces of information, program 104 preferably compares them to records contained in the membership information database 119 to determine if they correspond to an active membership. If the community operator is unable to confirm that the person is a member, a message is preferably transmitted to PDA 113 or user terminal 114 directing the person to the turnaround feature. As described above, the message is preferably in the form of a pop-up window generated using known programming techniques.

If the community operator determines in step 176 that the person seeking to buy an item is a community member, then the community operator preferably charges the person's credit card credit card account in step 180 in an amount equal to the initial community offer discount price from step 148. As explained above, processes for automatically performing credit card transactions over communication networks such as the internet are known to those of ordinary skill in the art and will not be described herein. If the credit card transaction is approved by the credit card processor, the community operator preferably transmits a confirming response to the buyer in step 181 indicating that the purchase has been completed.

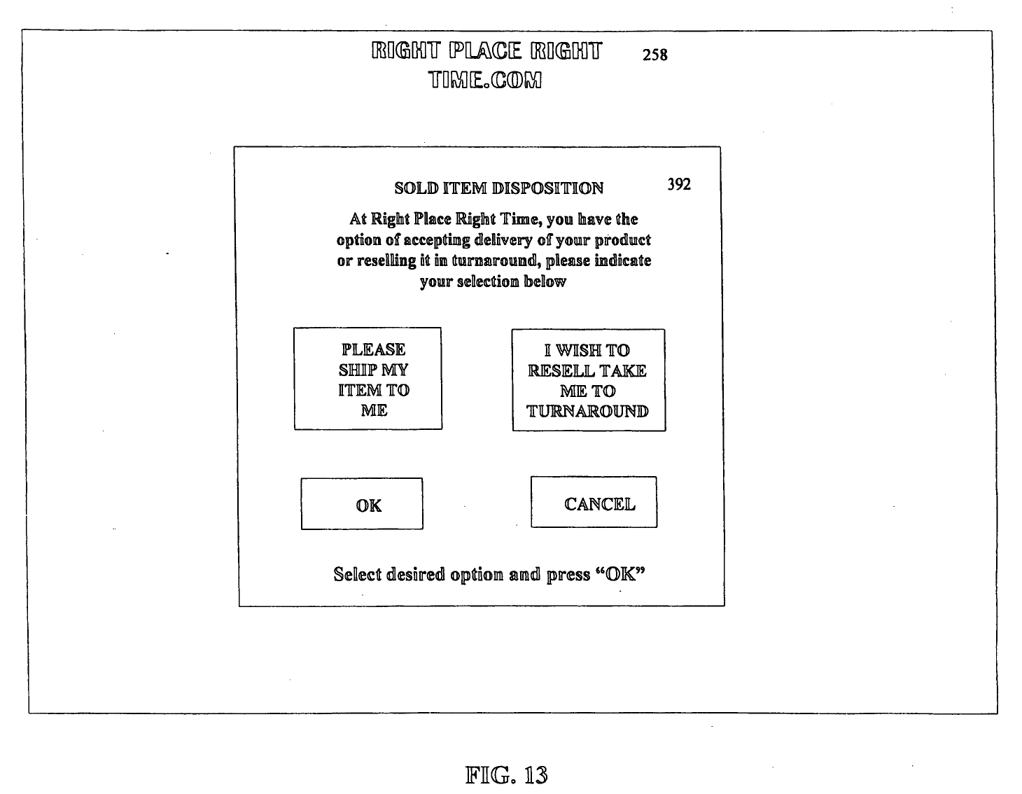

In accordance with the method of this embodiment, once a member of the community buys a unit of goods in step 180, the community operator then determines whether the buyer wants to resell the purchased item via the turnaround feature or instead take delivery of it (step 182). Preferably, program 104 generates a pop-up window 392 which appears on PDA 113 or user terminal 114 to display these two options to the buyer, as shown in FIG. 13. The pop-up window is preferably configured to allow the user to click on an area of the window to select the desired option, which is then transmitted to program 104. If the buyer elects to take delivery of the item, in step 184 the item is shipped to him, preferably within one day of the purchase to minimize storage costs. If services are sold instead of goods, performance may be scheduled at a pre-selected time or left to the mutual agreement of the buyer and vendor.

If the buyer elects to resell a purchased item in step 182, he is preferably directed to the market exchange or turnaround feature of the system. As will be explained below, the turnaround feature allows the user to resell the purchased item for a resale period of time. When the sold item is a good (and not a service), once the resale period expires, the item is shipped to the buyer if it has not been resold. In a preferred embodiment, the resale period is equal to the initial community offer period (step 148) less the elapsed time between the transmission of the initial community offer and the buyer's purchase of the item. For example, if in step 148 the initial community offer period is one (1) week and a first buyer purchases the item after three (3) days (step 180), then the resale period would be four (4) days. After the expiration of the resale period, if the item is not re-sold, it would be shipped to the buyer, preferably within one (1) day of the expiration of the resale period.

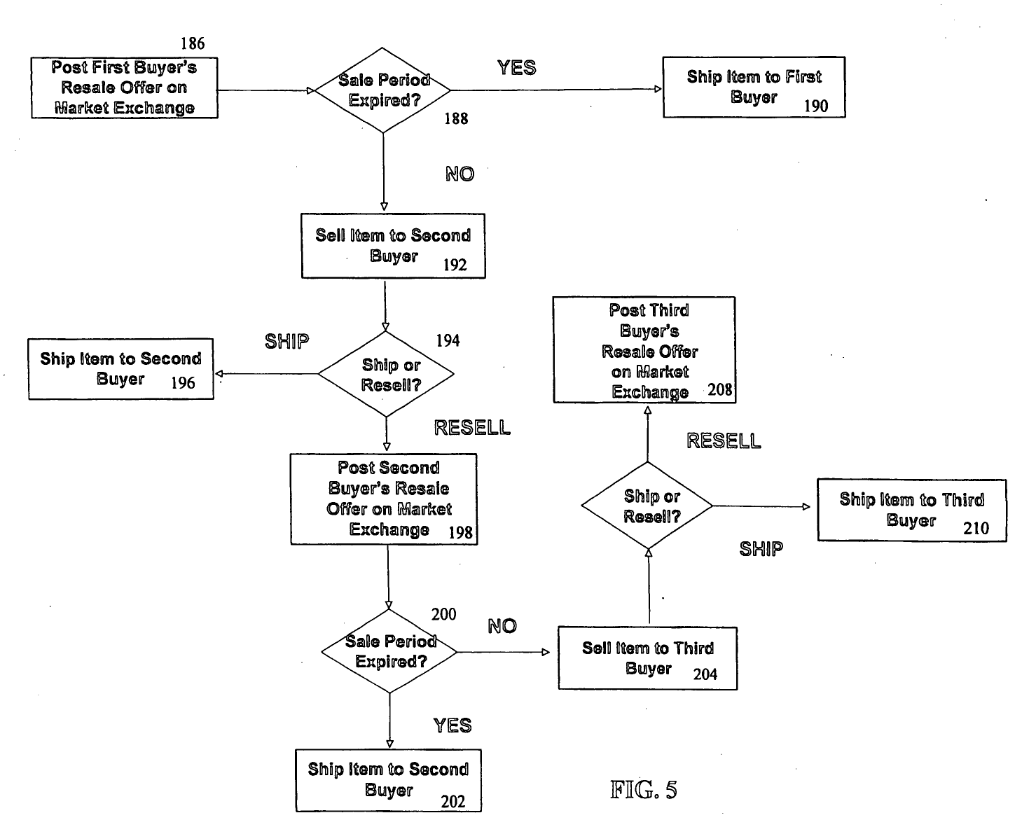

An embodiment of a method for reselling goods in accordance with the turnaround feature of the present invention is depicted in FIG. 5. As indicated in step 186, after a first buyer purchases one of the goods offered for sale in the initial community offer (step 148), he may offer to resell the item to members of the community at a first resale price. In a preferred embodiment, a resale offer may also be made to non-community members. In an especially preferred embodiment, the first resale offer is transmitted to community and/or non-community members via the turnaround feature, which is preferably a market exchange or turnaround web page, as discussed below. It is preferred that the first resale price is capped at a fixed percentage of the discount price at which the item was offered for sale in step 148 to promote further resales of the item.

In accordance with this embodiment, once the first resale offer is transmitted, the community operator preferably determines if the initial community offer period defined in step 148 has expired. If the period has expired, in step 190 the item is shipped to the its current owner (i.e., the first buyer). If the initial community offer period has not expired, the community operator determines whether it has received a request to buy the item. If it has received such a request, in step 192 the item is sold to a second buyer. Step 192 can be conducted in a variety of ways. For example, the community operator may query the second buyer to determine if he is a member of the community in the manner described above. If he is a member, then the community operator may charge his credit card in an amount equal to the first resale price in the manner described above for step 180. If the second buyer is not a member, the community operator may obtain credit card account information and shipping address information for him to complete the purchase. This may be done in a number of ways, for example, by having program 104 generate a pop-up window on PDA 113 or user terminal 114 which requests shipping information and credit card information and transmits the credit card information to a credit card processing company for verification and payment. If the second buyer's credit card transaction is successfully processed, the community operator will preferably credit the first buyer's credit card account and transmit a message to the second buyer confirming the acceptance of his purchase. The amount of the credit will generally equal from about 80% to about 100% of the first resale price, preferably from about 85% to about 95% of the first resale price and more preferably from about 87% to about 93% of the first resale price. In an especially preferred embodiment, the difference between the first resale price and the credit will comprise a commission retained by the community operator in exchange for facilitating resale transactions.

As indicated in FIG. 5, the process of reselling one of the items sold in step 180 can be repeated numerous times until the initial community offer period expires, at which point the item (if it is a good) will be shipped to its current owner (i.e., the last person to buy it). Thus, in step 194 the second buyer is asked to indicate whether he wishes to take delivery of the purchased item or to resell it. As indicated previously, the buyer may indicate his desired option by selecting an area of a pop-up window 392 appearing on PDA 113 or user terminal 114 (FIG. 13). If the second buyer wishes to resell the item, a second resale offer to sell the item at a second resale price will preferably be transmitted via the turnaround feature in step 198. The second resale offer will preferably be held open for a second resale period. The second resale period will preferably equal the difference between the initial community offer period (step 148) and the elapsed time between the initial community offer and the transmission of the second resale offer. As indicated in step 200, once the second resale period expires the item will be shipped to the second buyer if it has not yet been sold to a third buyer. As steps 202-210 indicate, the resale process may preferably continue a number of times until the fixed period of time for the initial community offer period expires.

In accordance with this embodiment, a speculative environment is created where community members may purchase or hold items with the goal of eventually reselling them to other community members or to non-members. This speculative environment will preferably result in items being re-sold several times at progressively increased prices. As a result, those purchasing items or observing the various transactions on web site 258 and turnaround feature 286 will preferably communicate information about the sales and resales to non-members of the community. This will preferably cause consumer interest to spillover to non-members of the community and a corresponding increase in purchases of the good from conventional retail outlets. As a result, this embodiment can preferably be used as a method to market goods or services by creating short term speculative purchases and sales of them.

An example of the embodiment of FIGS. 4 and 5 is set forth in Table 1. In this example, an initial quantity of 100 wallets is offered to a community of 150 members at $10.00 each for an initial community offer period of one (1) week (i.e., 168 hours). After two (2) days, the initial quantity of 100 wallets has sold out. As a result, in step 172 (FIG. 4) those wishing to purchase a wallet are directed to the market exchange.

TABLE 1

| First Buyer | Second Buyer | Third Buyer |
|---|---|---|
| Buys wallet for | Buys wallet from | Buys wallet from |
| $10.00, 46 hours | first buyer for | second buyer for |
| after initial offer | $12.00 at 72 hours | $16.00 at 110 hours |
| is transmitted | after initial offer | after initial offer |
| | is transmitted. | is transmitted. |
| Posts wallet for | Posts wallet for | Posts wallet for |
| resale on market | resale on market | resale on market |
| exchange for $12.00 | exchange for $14.00 | exchange for $16.00 |
| Maximum first | Maximum second | Maximum third resale |
| resale period is 168 | resale period is 168 | period is 168 hours − 110 |
| hours − 46 | hours − 72 hours = 96 | hours = 58 |
| hours = 122 hours | hours | hours |
| | | Wallet remains |
| | | unsold at expiration |
| | | of third resale |
| | | period and is |
| | | shipped to third |
| | | buyer |

In accordance with a preferred embodiment of the present invention, a purchase feature—preferably a graphical user interface—is displayed on PDA 113 or user computer 114 to facilitate the purchase of goods in accordance with embodiments of the present invention. Referring to FIG. 8, a preferred embodiment of a home page 258 for a web site is provided. Home page 258 is preferably generated using known programming techniques and is more preferably configured to receive and transmit information to program 104 and/or database server 102. Home page 258 preferably includes a product description field 260 which includes text describing the product offered for sale. Time remaining field 262 preferably provides a running indication of the time remaining until the expiration of the initial community offer period. Price field 264 identifies the initial community offer price. The price shown in field 264 preferably matches the price identified in the offer e-mail of FIG. 7A.

As mentioned earlier, items offered for sale in accordance with preferred embodiments of this invention will preferably have a suggested or normal retail price at which they are made available to the public through conventional retail outlets. Field 266 preferably indicates the normal or suggested retail price. Field 268 preferably identifies the number of units currently available to purchase or hold. In an especially preferred embodiment, the data in field 268 will be updated by program 104 as it calculates the quantity of goods currently available in the manner described previously. However, in another preferred embodiment, the data in field 268 will be non-numeric, comprising text such as “AVAILABLE” or “NOT AVAILABLE,” which informs potential buyers whether units are available without indicating the quantity that is available.

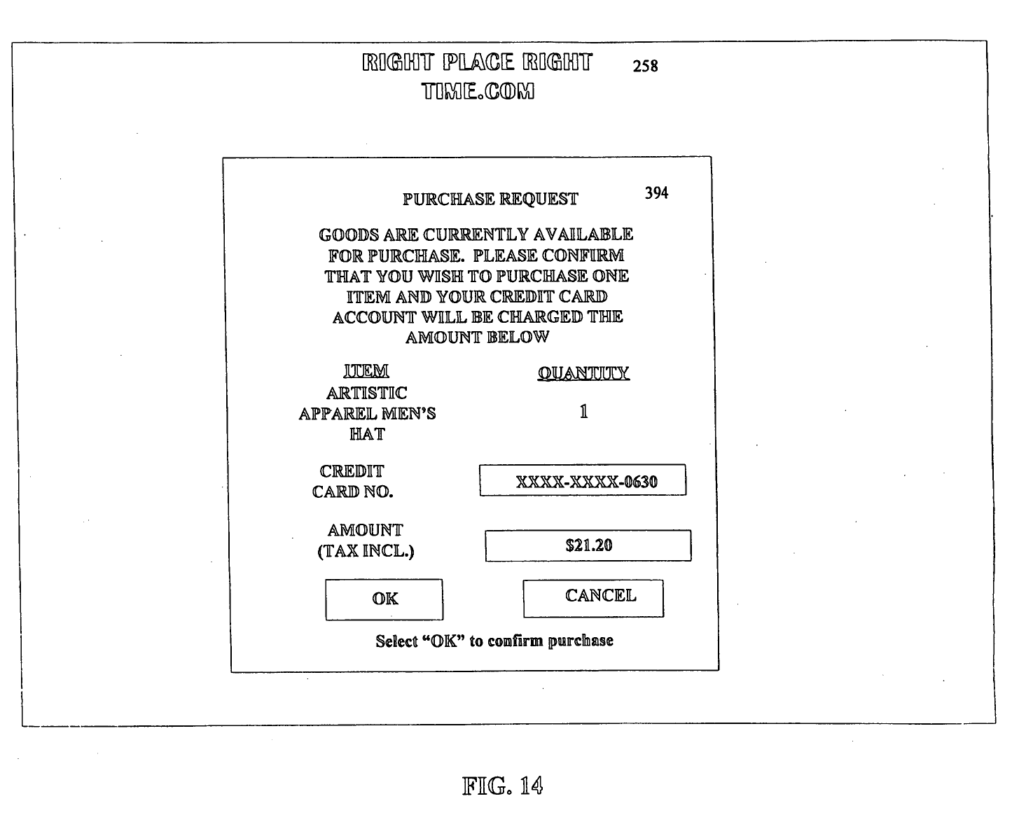

Server system 100 preferably includes a purchase feature to allow members to purchase goods offered for sale in the initial community offer. In a preferred embodiment, this purchase feature comprises a field 268 which is configured to allow users to click on it to indicate their desire to buy one of the goods offered for sale. In a preferred embodiment, a user selects field 268, causing program 104 to generate a pop-up window 394 asking the user if he or she wants to purchase one of the goods offered for sale, as shown in FIG. 14. The pop-up window preferably allows the user to confirm his desire to purchase one of the goods by selecting (with a mouse or cursor) an area of the pop-up window. This selection preferably results in a charge being applied to the user's credit card (step 180 in FIG. 4) in an amount equal to the price of the item (plus any applicable sales taxes), as explained above.

Field 270 preferably identifies the number of units on-hold, which will equal the number of units for which hold requests have been accepted and for which the hold period has not yet expired. Field 270 is preferably configured to allow users to click on it to indicate their desire to put one of the goods offered for sale on hold. Preferably, the selection of field 270 in this manner will cause program 104 to display pop-up window 390, as shown in FIG. 12 and described previously.

As mentioned previously, in accordance with certain preferred embodiments of the present invention, members of the community who purchase items offered for sale can optionally accept delivery of those items or offer to resell them to members of the community and/or non-members of the community. Turnaround units field 272 preferably indicates the number of items that are currently being offered for resale via the turnaround feature, which as explained previously, is preferably a market exchange website.

To generate interest in the item offered for sale, home page 258 preferably includes image 274 of the offered goods. Image 274 is preferably stored in product information database 120 as an image file that is linked to home page 274 using known programming techniques. By selecting field 276 (such as with a mouse or cursor) users are preferably able to access another web page (not shown) which describes upcoming offers.

Users can preferably select field 278 to access the turnaround or market exchange area web page where resale offers are presented. Optionally turnaround unit field 272 may be configured to allow users to click on it to access the market exchange web page.

Field 280 preferably allows users to join the community of buyers. In a preferred embodiment, users select field 280, causing program 104 to display membership information input screen 372 (FIG. 3A) to the user's computer 114 or PDA 113. Field 284 is preferably provided to display the current date and time.

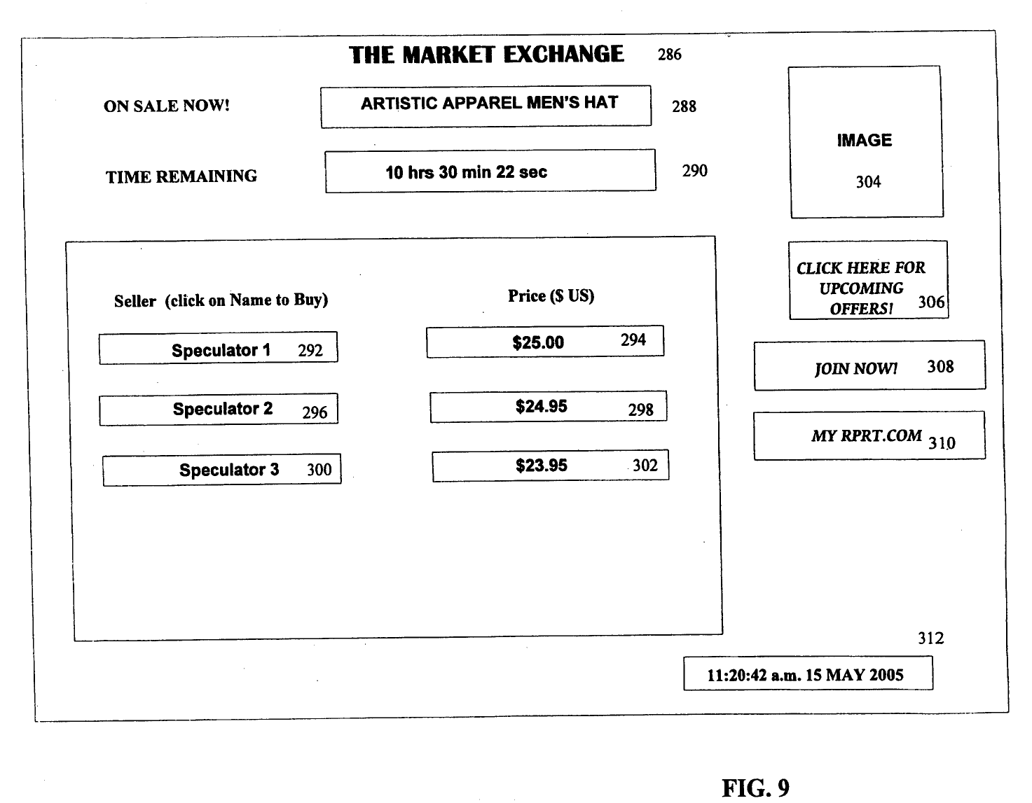

As mentioned above, in preferred embodiments of the present invention, members of the community who purchase items in response to an offer can optionally resell those items to members and/or non-members of the community. To facilitate such resales, a turnaround feature, preferably comprising a turnaround or market exchange web page 286 is provided. An example of a turnaround web page is provided is depicted in FIG. 9. Turnaround web page 286 preferably includes product description field 288 and time remaining field 290. In addition, seller fields 292, 296, and 300 and corresponding resale offer price fields 294, 298, and 302 are preferably provided to display the items currently being offered for resale. Those wishing to purchase turnaround items preferably select the desired seller or price field to cause program 104 to display a pop-up window which requests the user's community membership (for members) or credit card information (for non-members) to complete the purchase.

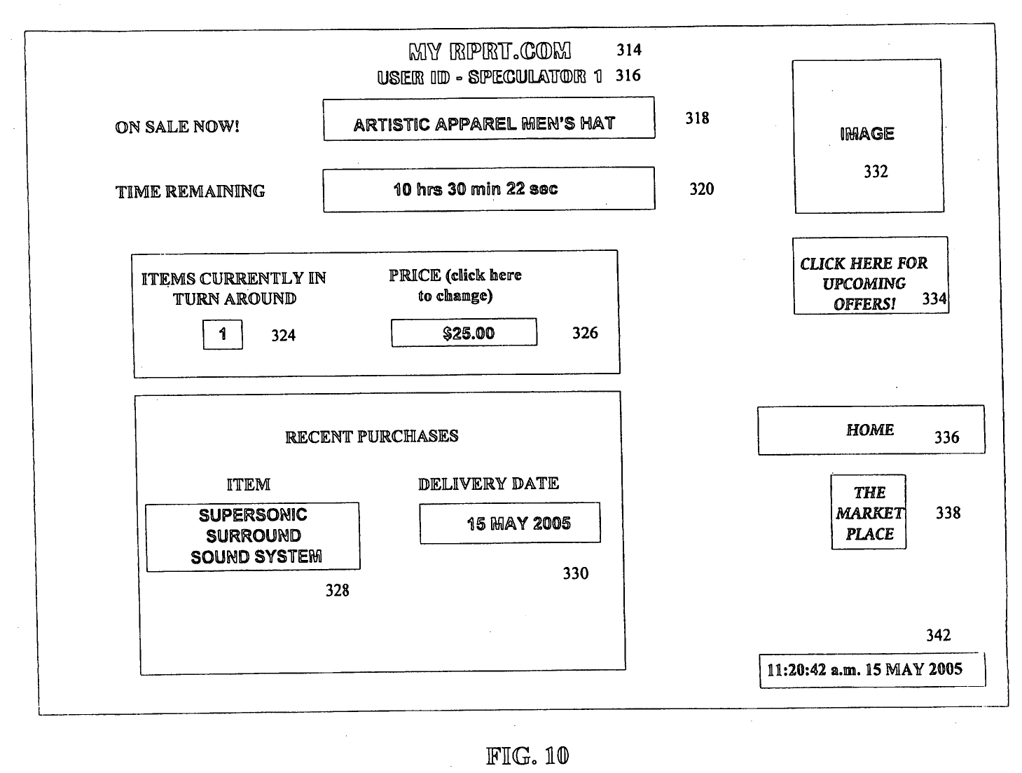

Users are preferably provided with their own home pages which provide information about their purchases. A preferred embodiment of a user home page 316 is provided in FIG. 10. User home page 316 is preferably provided to community members only. It also preferably includes a user identification field 316, which includes the user's identification name. Product description field 318 preferably provides information about the product being offered for sale, and time remaining field 320 preferably indicates the time remaining until the end of the initial community offer period.

User home page 314 also preferably displays information about the items that the user has posted for resale on the market exchange web page 286. Field 324 preferably indicates the number of items the user is offering for resale on the market exchange, and field 326 preferably indicates the current resale price at which the user is offering to sell the item. In an especially preferred embodiment, each membership will entitle a community member to purchase one of the items offered for sale in the initial community offer. However, members will preferably be allowed to purchase additional items from the market exchange. Thus, at any given time, members may offer more than one item for resale on the market exchange: one item obtained from the initial community offer and other items purchased from the market exchange. However, the community operator may allow one person to purchase more than one community membership, each of which generates a fee for the community operator and entitles the person to purchase one unit of a product offered for sale at the initial community offer price.

User home page 314 may also include information concerning the community member's recent purchases. Thus, item field 328 preferably describes items that the member recently purchased, and delivery date field 330 preferably indicates the expected delivery date for those items. In this way, members can keep track of their purchases and make any necessary arrangements to receive shipped items.

As with home page 258, user home page 314 preferably includes an image field 332 for displaying an image of the product currently being offered for sale as well as an upcoming offer field 334, which allows users to access a web page describing upcoming offers. User home page 314 also preferably includes a home page field 336, which the user can select to access home page 258, a market exchange field 338, which the user can select to access market exchange web page 286 and a current time field 342 which displays the current date and time.

In accordance with a preferred embodiment of the present invention, server system 100 is configured to generate a vendor report 346. Vendor report 346 preferably provides sale statistics and objective evidence of consumer interest for the vendor's products. To facilitate the generation of vendor report 346, program 104 is preferably configured to store information concerning recent sales to a recent sales database (not shown). A variety of different interfaces can be used to allow vendors to generate the report. For example, vendors could select a vendor report field 339 provided on home page 258 (FIG. 8) to cause program 104 to display a pop-up window. Vendors would then enter appropriate vendor identification and password information in the pop-up window, thereby prompting program 104 to generate report 346.

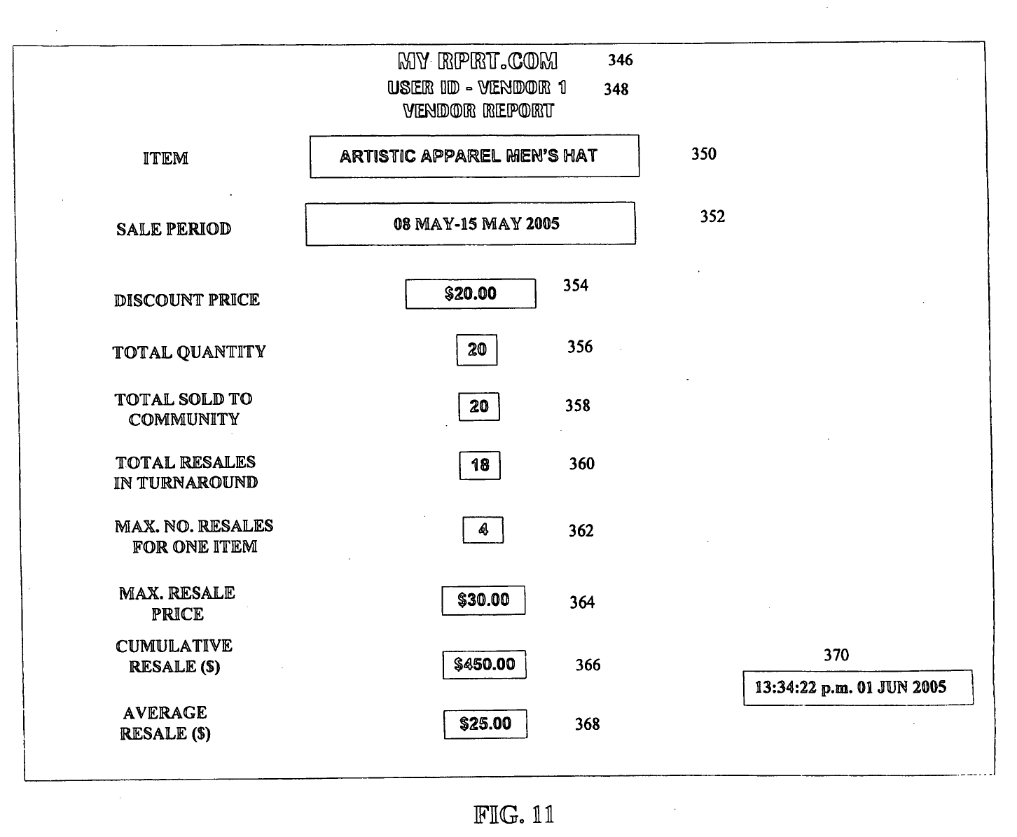

A preferred embodiment of a vendor report 246 is provided in FIG. 11. Vendor report 346 preferably provides a user identification name for the vendor 348, a product description field 350, and a sale period field 352, which identifies the dates during which the sale was conducted.

Fields describing the total quantity of goods offered for sale to the community 356, the total quantity of goods sold to the community 358, and the total number of sales made in the market exchange or turnaround 360 are also preferably provided. In addition, vendor report 346 preferably includes a maximum number of resales for one item field 362, which indicates the greatest number of resales which were made for any one unit. Field 364 preferably displays the maximum resale price obtained in the market exchange for any one item, as well as the cumulative resale dollars received by all resellers 366, and the average resale price 368 for all resellers. In accordance with this embodiment, vendors can present their vendor reports to commercial retail outlets as a means of convincing them that consumer interest is sufficient to warrant selling the vendor's goods or services and as a means of convincing such outlets of the price at which the vendor's goods or services are likely to sell.

The embodiments described above are exemplary embodiments of a the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A method of selling a fixed quantity of a product during a fixed period of time, comprising:
transmitting a first offer to sell the product to a community of buyers;
transmitting a first resale offer to sell a unit of the product to the community of buyers, wherein the first offer to sell and the first resale offer to sell expire no later than the fixed period of time expires.

2. The method of claim 1, wherein the product is one selected from the group consisting of a good and a service.

3. The method of claim 1, wherein one unit of the product is sold to a first buyer in the community of buyers, thereby defining a first sale and a sold product, and the first resale offer to sell comprises a first resale offer to sell the sold product.

4. The method of claim 1, wherein the step of transmitting a first offer to sell occurs at an offer transmission time, the first sale occurs at a first sale time, the first sale time and the offer transmission time define a first sale period between the offer transmission time and the first sale time, and the first resale period is no more than the difference between the fixed period and the first sale period.

5. The method of claim 3, wherein the product is a good, and the method further comprises the step of transmitting an inquiry regarding the disposition of the sold good to the first buyer after the first sale of the good, wherein the diposition is one selected from the group consisting of shipping the sold good to the first buyer and reselling the sold good to the community of buyers.

6. The method of claim 1, wherein the step of transmitting a first offer to sell the product to a community of buyers comprises transmitting an electronic mail message to at least a portion of the community of buyers.

7. The method of claim 6, further comprising the step of providing a world wide web interface, and wherein the electronic mail message is transmitted to the at least a portion of the community of buyers via the world wide web interface.

8. The method of claim 6, further comprising the step of providing a wireless application protocol interface, and wherein the electronic mail message is transmitted to the at least a portion of the community of buyers via the wireless application protocol interface.

9. The method of claim 1, wherein the step of transmitting a first offer to sell the product to a community of buyers comprises transmitting a cellular telephone text message to at least a portion of the community of buyers.

10. The method of claim 1, wherein the first offer to sell comprises a community price, and the first resale price is not more than a fixed percentage of the community price.

11. The method of claim 3, wherein the sold unit of the product is resold to a second buyer, thereby defining a second sale of the sold unit of the product, the method further comprising transmitting a second resale offer to sell the sold unit of the product to the community of buyers, the second resale offer comprising a second resale price and expiring no later than a second resale period expires.

12. The method of claim 11, wherein the second sale of the product occurs at a second sale time, the offer transmission time and the second sale time define a second sale period between the offer transmission time and the second sale time, and the second resale period is the difference between the fixed period of time and the second offer period.

13. The method of claim 1, wherein the product is a good, and wherein following the fixed period the fixed quantity of goods comprises a quantity of sold goods, each sold good has a corresponding owner, and each sold good is shipped to its corresponding owner.

14. The method of claim 1, wherein the product has a vendor and the method further comprises providing a vendor transaction report, the vendor transaction report comprising a number of sales transactions conducted during the fixed period and a sales price corresponding to each transaction.

15. A method of selling a fixed quantity of a product during a fixed period, the method comprising:
transmitting an offer to sell the product to a community of buyers;
receiving a request from a member of the community of buyers to purchase a unit of the product;
determining a quantity of the product currently held;
determining a quantity of the product sold;
determining whether any units of the product are currently available for purchase based on the fixed quantity of the product, the quantity of the product currently held and the quantity of the product sold;
transmitting to the member a response to the request to purchase a unit of the product, wherein the response is based on whether any units the product are currently available for purchase.

16. The method of claim 15, further comprising receiving at least one request to hold one unit of the product for a hold period, wherein the step of determining the quantity of the product currently held comprises determining whether the hold period has expired.

17. The method of claim 15, wherein at least one unit of the fixed quantity of the product is sold to a buyer, thereby defining a quantity of sold product, each sold product has a corresponding buyer, and the response comprises a message directing the member to a turnaround feature.

18. The method of claim 17, wherein the message directing the member to one of the buyers comprises a message directing the member to a market exchange page of a web site.

19. A system for selling a fixed quantity of a product, the system comprising a computer server programmed to transmit a first offer to sell the product to a community of buyers and transmit resale offers to sell the product to the community of buyers, wherein the first offer and the resale offers expire no later than a fixed period of time following a transmission of the first offer to sell to the community of buyers.

20. The system of claim 19, wherein the computer server is operatively connected to a communications network.

21. The system of claim 20, wherein the communications network comprises at least one selected from the group consisting of a local area network, a wide area network, the internet, and a cellular telephone network.

22. The system of claim 20 wherein the communications network is a wireless communications network.

23. The system of claim 19, wherein the server has a product information database stored thereon, the product information database includes a plurality of data fields related to at least one product, and the first offer includes information contained in at least one of the data fields for at least one of the products.

24. The system of claim 19, wherein the offer comprises at least one selected from the group consisting of a picture of the product, a description of the product, a retail price for the product, and a discount price for the product.

25. The system of claim 19, wherein the product has a vendor and the server is further programmed to provide a vendor transaction report, the vendor transaction report comprising a number of sales transactions conducted during the fixed period and a sales price corresponding to each transaction.

26. A computer readable medium having instructions stored thereon for causing a computer to: (a) transmit a first offer to sell a fixed quantity of a product to a community of buyers; and (b) transmit a first resale offer to sell a sold unit of the product to the community of buyers, wherein the first offer to sell and the first resale offer to sell expire no later than a fixed period of time following a transmission of the first offer to sell to the community of buyers.

27. The computer readable medium of claim 26 further having instructions programmed thereon to accept a request to purchase the product, whereupon one of the units of the product becomes a sold product.

28. The computer readable medium of claim 27, wherein the transmission of the first offer to sell defines an offer transmission time, an acceptance of a request to purchase a unit of the product defines a first sale time, the offer transmission time and the first sale time define a first sale period between the offer transmission time and the first sale time, and the first resale offer is held open for a first resale period that is no more than the difference between the fixed period of time and the first sale period.

29. A method of marketing a product having a retail price, comprising:
offering a fixed quantity of the product for sale to a community of buyers at a discount price for no more than a fixed period of time;
selling at least one unit of the product in the fixed quantity of the product to a buyer in the community of buyers, thereby defining a sold product;
reselling the sold unit of the product at least once during the fixed period of time.

30. The method of claim 29, wherein the product has a vendor and the method further comprises providing a vendor transaction report, the vendor transaction report comprising a number of sales transactions conducted during the fixed period and a sales price corresponding to each transaction.

31. A system for selling a fixed quantity of a product during a fixed period of time, the system comprising a computer server programmed to perform the following steps:
transmit an offer to sell the product to a community of buyers;
receive a request from a member of the community of buyers to purchase a unit of the product;
determine a quantity of the product currently held;
determine a quantity of the product sold;
determine whether any units of the product are currently available for purchase based on the fixed quantity of the product, the quantity of the product currently held and the quantity of the product sold;
transmit to the member a response to the request to purchase a unit of the product, wherein the response is based on whether any units of the product are available for purchase.

32. The system of claim 31, wherein the server is further programmed to receive at least one request to hold a unit of the product for a hold period, and the step of determining the quantity of the product currently held comprises determining if the hold period has expired.

33. A system for selling a fixed quantity of a product comprising a computer server programmed to include:
a purchase feature configured to receive requests to purchase the product during a fixed period of time;
a hold feature configured to receive requests to purchase an option to buy the product during an option period, wherein the option period expires no later than the fixed period of time expires.

34. A system for selling a product, comprising a computer server programmed to include:
a purchase feature configured to receive requests to purchase the product during a fixed period of time;
a turnaround feature configured to transmit offers to resell sold units of the product for a period of time that expires no later than the fixed period of time expires.
